(19) United States
(12) Patent Application Publication
(10) Pub. No.: US 2015/0341229 A1
(43) Pub. Date: Nov. 26, 2015

(54) LOAD GENERATION APPLICATION AND CLOUD COMPUTING BENCHMARKING

(71) Applicant: Krystallize Technologies, Inc, Fulshear, TX (US)

(72) Inventors: Roger Richter, Leander, TX (US); Clinton France, Fulshear, TX (US)

(21) Appl. No.: 14/716,862

(22) Filed: May 19, 2015

Related U.S. Application Data
(60) Provisional application No. 62/000,925, filed on May 20, 2014.
(60) Provisional application No. 62/040,174, filed on Aug. 21, 2014.
(60) Provisional application No. 62/110,442, filed on Jan. 30, 2015.

(51) Int. Cl. H04L 12/24; H04L 29/08; H04L 12/26

(52) U.S. Cl. CPC H04L 41/5035; H04L 43/08; H04L 67/10

(57) ABSTRACT

Benchmarking of a cloud computing instance is performed by a benchmarking application via direct system calls and locally stored measures to lower impact on benchmarking. Furthermore, stored measures are uploaded to a server when benchmarking is not being performed, so as not to have the uploading impact measurement. The benchmarking is performed via an application profile comprising a plurality of benchmark indicia. Benchmarking indicia may be specific to 64-bit operating systems. Benchmarking indicia may be variable, in which a thread pool in the benchmarking application increases or decreases active threads based on the variance of the benchmarking indicia. In this way, a benchmarking application can simulate an application load not only by benchmarking indicia, but also by time.

### CROSS REFERENCE TO RELATED PATENT APPLICATIONS

This patent application claims priority to U.S. Provisional Patent Application No. 62/000,925 entitled “Smart Application for Cloud Benchmarking” filed May 20, 2014, U.S. Provisional Patent Application No. 62/040,174 entitled “Load Generation Application for Platform Performance Management” filed Aug. 21, 2014, and U.S. Provisional Patent Application No. 62/110,442 entitled “Load Configuration Generation and Variable Intensity Settings” filed Jan. 30, 2015, all of which are hereby incorporated in their entirety by reference.

### BACKGROUND

Enterprises and other companies may reduce information technology (“IT”) costs by externalizing hardware computing costs, hardware maintenance and administration costs, and software costs. One option to externalize IT costs is by purchasing cloud computing processing and hosting from a third party cloud computing provider. Cloud computing providers purchase and maintain computer servers typically in server farms, and act as a utility company by reselling their computing capacity to customers. Some customers may be value added resellers (“VARs”) that are software companies who host their software applications on computing capacity from cloud providers. These VARs then make money by selling access to their software applications to customers. In this way, cloud computing providers directly externalize hardware computing costs and hardware maintenance costs, and indirectly externalize software costs by providing a hosting platform for VARs.

Cloud computing providers typically add infrastructure services that provide common services for the cloud provider. Some infrastructure services are operating system-like services that control allocation of services of the cloud. For example, physical servers in server farms are typically disaggregated and resold in unitary blocks of service in the form of processing power, memory, and storage. Specifically, a unitary block is some unit to inform a customer of the volume of computing capacity purchased from a cloud provider. Consider a customer that purchases a unitary block of denoted, for example, one “virtual processor”. That customer may in fact be purchasing processing power where the virtual process is provided by different cores on a processor, different processors on the same physical server, or potential processing cores on different physical servers. The unitary block measuring computer service is proffered by the vendor, rather than a third party operating at arm's length.

Other infrastructure services provide services that support the cloud provider business model. For example, cloud providers typically provide different billing options based on metering a customer's usage on the cloud. A billing infrastructure is an example of an infrastructure service that supports the cloud provider business model. However, metering, service level agreements, and ultimately billing are often provided in terms of a vendor's chosen unitary measure.

Accordingly, customers are obliged to independently verify vendor claims about the unitary measure, or alternatively simply take the vendor at their word. Thus customers are faced with evaluating cloud provider claims without a ready point of reference.

Verification of claims about unitary services is not trivial. Cloud providers use infrastructure services as competitive differentiators to attract customers and VARs. For example, yet other infrastructure services provide abstractions that facilitate application development and hosting on the cloud. Well known examples include Platform-as-a-Service (“PAAS”), Infrastructure-as-a-Service (“IAAS”) and Software-as-a-Service (“SAAS”) hosting and development infrastructure.

Thus additionally, customers who seek to compare cloud providers are faced with evaluating different hardware configurations, different software configurations, and different infrastructure services, often without transparency to the operation of different cloud providers.

### BRIEF DESCRIPTION OF THE DRAWINGS

The Detailed Description is set forth with reference to the accompanying figures.

FIG. 1 is a top level context diagram for cloud computing benchmarking.

FIG. 2 is a hardware diagram of an exemplary hardware and software platform for cloud computing benchmarking.

FIG. 3 is a system diagram of an exemplary embodiment for cloud computing benchmarking.

FIG. 4 is a flowchart of an exemplary dispatch operation for cloud computing benchmarking.

### DETAILED DESCRIPTION

### Cloud Computing and Benchmarking

### Measurement and Benchmarking

The present disclosure describes benchmarking from the perspective of benchmarking cloud computing. Before discussing benchmarking cloud computing, the present disclosure will describe some preliminaries regarding benchmarking.

Benchmarking is the selection of one or more indicia that are used to compare one item to another or one item to an idealized version of that item. In the case of computer science, common comparative indicia may include software performance, hardware performance, overall system performance. For example volume of data processed, number of faults, and memory usage may be candidate metrics for benchmarking software performance. A particular software implementation may be compared to a competing implementation. Alternatively, the software implementation might be compared to the theoretical optimum values of those metrics. Regardless of what metrics are chosen, the aggregating of those chosen metrics constitutes benchmarking.

Since the indicia chosen to constitute a benchmark are used for comparisons, the indicia chosen are to be based on a measure. A measure is sometimes called a distance function that is a value based on a comparison. Measure can be categorized by their behavior upon comparing measure values, called measurements, against each other. Measures may come in the following four categories.

i. Different Categories

Indicia may be placed in different categories. Here, the indicia indicates what kind of item, something is. It does not indicate whether something is better or worse than another item. Rather it simply indicates that it is different and should be treated and/or evaluated differently. For example, a cloud infrastructure service might be classified as PAAS, IAAS, or SAAS. None of the three options are necessarily better or worse, rather just in different categories.

ii. Ordered Categories

Indicia may be placed in ordered categories. Here, the categories have a clear order as to which categories is more desirable. Typically the categories are ordered in monotonically increasing order, such as from worst to best. For example, customer satisfaction with a cloud vendor might be classified from “bad”, “average”, “good” and “excellent.” Therefore, a cloud vendor classified as “excellent” might be considered better than another classified as “average.” However, there is no indication of degree of how much better an “excellent” vendor is over another that is merely “average.”

iii. Additive Categories

Indicia may be additive. Additive indicia allow multiple measurements to be aggregated into a single measurement, where order is preserved. For example, number of processors on a server for parallel processing is additive. Two processors generally are able to do more processing than one processor. However, two processors are not necessarily able to do twice as much processing as one processor, due to communications overhead and/or the possibility of the processors being heterogeneous. So additive indicia do not scale.

iv. Scalable Measurements

Indicia may be scalable. Not only are scalable indicia additive, scalable indicia support all arithmetic operations including multiplication and division. For example, megaflops per second (“MFLOPS”) is an indicia that is a scalable measure. A processor that can perform 2,500 MFLOPS is two and half times as powerful as a processor that can perform 1,000 MFLOPS.

Additive and scalable measures are sometimes called metrics, because the distance function comprising the measure satisfies the mathematical properties of separation, coincidence, symmetry and the triangle inequality. Regarding the latter, a measure satisfies the triangle inequality if the measurements between A and C is greater than or equal to the measurement between A and B added to the measurement between B and C. Expressed mathematically, F(x, y) satisfies the triangle inequality if:

F(A,C)≦F(A,B)+F(B,C).

Metrics provide the basis for performing statistical functions, many of which are based on arithmetic operations. Accordingly, metrics are desirable measures, because they enable statistical techniques to be brought to bear during analysis. For example, consider the function for a standard deviation:

$$stddev ( x ) = \sqrt{\frac{{\sum }_{i = 1}^{n} ( x - {\overline{x}}^{2} )}{n - 1}}$$

The standard deviation function is comprised of square roots and exponents which use multiplication, summations which use addition, averages which use division, and the like. Thus the standard deviation function is mathematically and statistically meaningful where a metric is used as a measurement.

### Goals in Benchmarking Cloud Computing

Turning to the application of benchmarking to cloud computing, there are several potential cloud provider evaluation goals that are driven by business operations. The evaluation goals may include a potential business decisions to:
move to an alternative cloud provider;
evaluate a service design of a cloud provider;
verify continuity of service from a cloud provider over time;
verify consistency of service over different service/geographic zone for a cloud provider;
verify a cloud provider can support a migration to that cloud provider;
enable service/price comparisons between different cloud providers;
verify terms of a service level agreement are satisfied;
evaluate performance times hibernation and re-instantiation by services of a cloud provider;
performance; and
evaluate and validate service change management in a cloud provider.

These evaluation goals may be achieved by identifying and selecting indicia to comprise a benchmark. The indicia may support simple difference comparisons, between one or more systems. Alternatively, the indicia may provide the basis to define a measure in terms of one or more normalized units to make baseline measurements. Defining a normalized unit that supports a metric enables bringing not only direct comparisons, but also statistical techniques to support a comprehensive evaluation.

The selected indicia are chosen on the basis of either being an indicia of a cloud provider's performance, functionality, or characteristics, known collectively as a PFC. Performance indicia are artifacts that indicate how a cloud provider performs under a work load, for example processor usage percentage. Functionality includes computing features that are available from the cloud provider, for example a maximum of 4 GB memory available to a virtual server instance. Characteristics differentiate categories for cloud providers, such as type of billing model. The selected indicia may be measured with varying frequency. In some situations, a single measurement may be made over the lifetime of a benchmarking cycle. In others, multiple measurements are made either periodically, according to a predetermined schedule, or upon detecting an event or condition.

Cloud computing benchmarks may comprise indicia that allow for the aggregation of measurements over time. Specifically indicia may be selected to continuously, periodically, or at selected intervals measure and track the overall performance capability over time. This enables the development of complex algorithms which may include for example the overall performance capabilities across systems; the impact of multiple demands on a system; impact to the system's capabilities; and their respective trend over time. A specific benchmark may be to capture the processor maximum performance over time, to capture the network throughput over time and to combine these measures based on a workload demand to generate a predictive model of what the maximum processor capability is given a variable network throughput. While this benchmark example outlines two indicia, by definition, the overall performance capability will be impacted by all of the demand on the cloud provider. Thus, the measurement of indicia is enhanced by the temporal view that enables adaptive and predictive modeling based on customer defined indicia.

Potential indicia include indicia in the following categories.

i. Compute

The compute category covers information about the physical and/or virtual processor cores used by servers in a cloud provider. In general, computing processors are known as computing processing units (“CPUs”). The following table lists potential indicia in the compute category.

TABLE 1
Compute Indicia

| | | Update | |
|---|---|---|---|
| Indicia | Description | Frequency | PFC Test |
| CPUs | How many CPU cores are | once | Functionality |
| allocated | configured for this server | | (Validation |
| | | | Test) |
| CPU usage | CPU usage percentage - one | frequent | Performance |
| per core | column of raw data per core | | (Stress Test) |
| CPU speed | Speed in gigahertz (GHz) of | once | Functionality |
| | each core in the CPU | | (Validation |
| | | | Test) |
| integer ops/sec | Number of integer math | frequent | Performance |
| | operations can be performed | | (Stress Test) |
| | in one second | | |
| float ops/sec | Number of single-precision | frequent | Performance |
| | floating-point math operations | | (Stress Test) |
| | can be performed in one | | |
| | second | | |
| user mode vs. | Percentage of CPU usage | frequent | Functionality |
| kernel mode | devoted to user processes vs. | | (Validation |
| vs. idle | the OS | | Test) |
| top 5 CPU | processes using the most CPU | frequent | Functionality |
| hogs | time | | (Validation |
| | | | Test) |
| thread count | How many threads are in use | frequent | Performance |
| | (per process, total for the | | (Stress Test) |
| | machine) | | |

ii. Memory

The memory category covers information about the physical and/or virtual (swap) random access memory (“RAM”) used by servers in a cloud provider. The following table lists potential indicia in the memory category.

TABLE 2
Memory Indicia

| | | Update | |
|---|---|---|---|
| Indicia | Description | Frequency | PFC Test |
| total RAM | How much RAM is allocated to | once | Functionality |
| | the server | | (Validation |
| | | | Test) |
| total swap | How much disk space is | once | Functionality |
| | allocated for swap space | | (Validation |
| | | | Test) |
| allocated | How much of the system's | frequent | Performance |
| memory | memory is currently in use | | (Stress Test) |
| page faults | Number of times that a process | frequent | Functionality |
| | requested something from RAM | | (Validation |
| | but it had to be retrieved from | | Test) |
| | swap | | |
| memory | Total/Allocated/free statistic | frequent | Performance |
| usage | for RAM and swap | | (Stress Test) |
| top 5 | processes using the most memory | frequent | Functionality |
| memory | | | (Validation |
| hogs | | | Test) |
| queue size | Amount of RAM devoted to data | frequent | Functionality |
| | for processes that are not | | (Validation |
| | currently active | | Test) |

iii. Disk

The disk category covers information about the storage media available via the operating system or disk drives used by servers in a cloud provider. The following table lists potential indicia in the disk category.

TABLE 3
Disk Indicia

| | | Update | |
|---|---|---|---|
| Indicia | Description | Frequency | PFC Test |
| total capacity | How much disk space is | once | Functionality |
| (per file | allocated to the server | | (Validation |
| system) | | | Test) |
| used capacity | How much disk space is used | frequent | Functionality |
| (per file | by the system | | (Validation |
| system) | | | Test) |
| disk writes/sec | How many disk writes can be/ | frequent | Performance |
| | have been performed in a | | (Stress Test) |
| | second | | |
| disk reads/sec | How many disk reads can be/ | frequent | Performance |
| | have been performed in a | | (Stress Test) |
| | second | | |
| permissions | check permissions to ensure | frequent | Functionality |
| | that applications have the | | (Validation |
| | proper amount of permissions | | Test) |
| | to act and that permissions for | | |
| | critical files have not changed | | |
| IOWAIT time | Processes that cannot act | frequent | Performance |
| (input/output | because they are waiting for | | (Stress Test) |
| wait time) | disk read/write | | |

iv. Operating System

The operating system (“OS”) category covers information about the operating system used by servers in a cloud provider. The following table lists potential indicia in the operating system category.

TABLE 4
Operating System Indicia

| | | Update | |
|---|---|---|---|
| Indicia | Description | Frequency | PFC Tests |
| Version | What OS Version is | once | Functionality |
| | running on the system | | (Validation |
| | | | Test) |
| kernel parameters | Any changes in kernel | frequent | Functionality |
| | parameters | | (Validation |
| | | | Test) |
| scrape the boot | Information gathered from | frequent | Functionality |
| screen | the console logs during | | (Validation |
| | system boot | | Test) |
| check syslog for | Check the console logs | daily | Functionality |
| errors | and other system logs for | | (Validation |
| | errors | | Test) |
| context switching | How much time have | frequent | Performance |
| time (to go from | processes spent switching | | (Stress Test) |
| user to kernel | from user application to | | |
| mode) | OS kernel mode | | |
| number of | Count of running | frequent | Performance |
| running | processes | | (Stress Test) |
| processes | | | |
| zombie processes | Child processes that did | frequent | Functionality |
| | not terminate when the | | (Validation |
| | parent process terminated | | Test) |

### 64-Bit Operating System Issues

Of interest is the ability for a benchmarking application to perform in a 64-bit environment. A benchmarking application may collect information about a 64-bit operating system when hosted on the 64-bit operating system. Some benchmarking indicia are specific to a vendor such as Red Hat Linux™ or Microsoft Windows™. To support comparison across different 64-bit operating system vendors, the following comprise a list of variables for 64-bit operating systems that are not specific to a vendor. Note that some of these variables are not specific to 64-bit operating systems, but may apply to any operating system.

The following operating system configuration parameters are ready once, at startup time, are static thereafter.
O/S Version
O/S Name
Kernel Version (if different from the above)
Fully Qualified Hostname
Primary IP address (ip0 or if0)
Primary MAC address (eth0)
Total number of CPU cores
CPU speed
Total Memory Size
Primary disk drive/partition and size (needed to map active root partition to actual disk device)

System Statistics/Benchmark Indicia: The following operating system statistics may be measured as benchmark indicia:
CPU Usage Related Statistics (for all CPUs, or per-CPU):
   CPU load in user space (need to know stats behavior)
   CPU load in kernel/system space
   CPU idle time or percent
   CPU I/O wait time or percent
   CPU IRQ time or percent
   CPU steal time or percent
Tasks, Threads and Scheduling
   Number of Context switches
   Total uptime
   Active Process count
   Active Thread count (system-wide)
   Blocked Thread count
   Inactive Thread count
   Kernel Task Scheduler Average Queue Depth
Memory Related Statistics:
   Memory Used
   Memory Free
   Pages Allocated
   Pages Committed
   Pages Free
   Number of Pages Swapped-out
   Number of Pages Swapped-in
   Number of Page Faults
List of Disks/Block Drivers
Per Block Driver:
   Read transactions/sec
   Bytes read/sec
   Write transactions/sec
   Bytes written/sec
   Number of reads merged
   Number of writes merged
   Average Read wait time (milliseconds or microseconds)
   I/Os in progress
Network Stats per IP interface:
   Interface name or ID
   Rx packets/sec
   Rx bytes/sec
   Tx packets/sec
   TX bytes/sec
   Rx multicast packets/sec
   Tx multicast packets/sec
   Rx overruns
System-wide Socket Statistics:
   Total Active Sockets
   Total Active TCP Sockets
   Total Active UDP Sockets
   Total Active Raw Sockets

v. Network

The network category covers information about the server's connection to its local area network (“LAN”) and to the Internet for servers in a cloud provider. The following table lists potential indicia in the network category.

TABLE 5
Network Indicia

| | | Update | |
|---|---|---|---|
| Indicia | Description | Frequency | PFC Tests |
| IP address/gateway/ | Basic information | once | Functionality |
| subnet mask | about the system's | | (Validation |
| | IP configuration | | Test) |
| upload speed | Time to send a file | frequent | Performance |
| | of known size to a | | (Stress Test) |
| | known external host | | |
| download speed | Time to receive a | frequent | Performance |
| | file of known size | | (Stress Test) |
| | from a known | | |
| | external host | | |
| number of IP connections | Total number of | frequent | Performance |
| | open TCP and UDP | | (Stress Test) |
| | socket connections | | |
| number of SSL (secure | Total number of | frequent | Performance |
| socket link) connections | connections over an | | (Stress Test) |
| (or per other interesting | enumerated list of | | |
| port) | ports relevant to the | | |
| | application running | | |
| | on the server | | |
| roundtrip ping time | Time to receive an | frequent | Performance |
| | ICMP echo from a | | (Stress Test) |
| | known host | | |
| traceroute to pre- | Connection time, | frequent | Performance |
| defined location | hop count, and route | | (Stress Test) |
| (including latency) | to a known host | | |
| DNS (domain name | Time to resolve a | frequent | Performance |
| server) checks | known hostname, | | (Stress Test) |
| using primary or | and which DNS | | |
| secondary DNS | server was used | | |
| ARP cache | ARP table of open | frequent | Functionality |
| | IP connections | | (Validation |
| | | | Test) |
| virtual IP (internet | List of all virtual IPs | frequent | Functionality |
| protocol address) | assigned to this host | | (Validation |
| | by its load balancer | | Test) |

vi. Database

The database (“DB”) category covers information about a structured query language (“SQL”) or noSQL database management system (“DBMS”) application running on servers in a cloud provider. The following table lists potential indicia in the database category.

TABLE 6
Database Indicia

| | | Update | |
|---|---|---|---|
| Indicia | Description | Frequency | PFC Tests |
| Database | Type and Version of the | once | Functionality |
| version | running database system | | (Validation |
| | | | Test) |
| DB writes | Time to write a transaction of | frequent | Performance |
| local | known size to the DB on the | | (Stress Test) |
| | localhost | | |
| DB writes | Time to write a transaction of | frequent | Performance |
| over IP | known size from a known | | (Stress Test) |
| | external host to the DB on the | | |
| | localhost | | |
| DB reads | Time to read a transaction of | frequent | Performance |
| local | known size from the DB on the | | (Stress Test) |
| | localhost | | |
| DB reads | Time to read a transaction of | frequent | Performance |
| over IP | known size to a known external | | (Stress Test) |
| | host from the DB on the | | |
| | localhost | | |
| DB | Time to perform a known math | frequent | Performance |
| calculation | calculation within the database | | (Stress Test) |
| growth rate | Check the current size of the | frequent | Functionality |
| of the DB | DB files, including raw | | (Validation |
| data files | datafile/partition size, row | | Test) |
| | count, etc. | | |

vii. Cloud Provider

The cloud category covers information about the cloud provider in which the server is instantiated. In some cases, the indicia may be in terms of a normalized work load unit. The following table lists potential indicia in the cloud provider category.

TABLE 7
Cloud Indicia

| | | Update | |
|---|---|---|---|
| Indicia | Description | Frequency | PFC Tests |
| Load unit | Detect when a load unit | frequent | Functionality |
| measurements | measurement check is delayed | | (Validation |
| from server | or missing from a given server | | Test) |
| stopped | | | |
| responding | | | |
| provisioning | Time to create a new server | frequent | Performance |
| speed CPU | instance of a given size in a | | (Stress Test) |
| | given availability zone (e.g. | | |
| | by creating a tailored area of | | |
| | mutual interest (AMI) to | | |
| | provision identical machines | | |
| | and report back about | | |
| | provisioning time) | | |
| Provisioning | Time to create new storage | frequent | Performance |
| speed Storage | | | (Stress Test) |
| migrate server | Time to create a snapshot and | frequent | Performance |
| to another | clone the instance of a server | | (Stress Test) |
| datacenter | in a different availability zone | | |
| cluster | Information about other | frequent | Functionality |
| information | servers related to this one, like | | (Validation |
| | server farms, database | | Test) |
| | clusters, application rings | | |

### Cloud Computing Benchmarking Issues

Selection of indicia for a benchmark may be driven by the consumer of the benchmark. A basis for a benchmark to be accepted by a consumer is that the consumer trusts the measurement. There are several factors that may affect the trust of a measurement.

i. The Observation Problem Aka Heisenberg

The act of observing a system will affect a system. When a measurement consumes computing resources as to affect the observable accuracy of a measurement, the measurement will not be trusted. This problem is also known as the “Heisenberg” problem. In the case of cloud computing, a benchmarking application running within a cloud instance will use processing, memory, and network resources. In particular, since cloud communications are typically geographically disparate, network latency during measurement may have a significant adverse impact on measurement accuracy. Furthermore, cloud infrastructure services often have sophisticated “adaptive” algorithms that modify resource allocation based on their own observations. In such situations, it is very possible that a benchmarking application may become deadlocked.

One approach is to guarantee performance overhead of a benchmarking application to be less than some level of load/processing core overhead. Measurements would be compared only on like systems. For example a Windows™ based platform would not necessarily be compared to a Linux platform. Also, memory and network overhead could be managed by carefully controlling collected data is transferred. For example, benchmark data may be cached on a local disk drive and will transfer upon an event trigger such as meeting a predetermined threshold to limit disk load. Since data transfer potentially creates network load, data may be transferred upon receiving a transfer command from a remote central controller.

Another approach may be to understand the statistical behavior of the system to be benchmarked. If an accurate statistics model is developed, then a statistically small amount of benchmarking data may be collected, and the measurement projected by extrapolation based on the statistics model. For example, a workload over time model may be developed where an initial measurement is made at the beginning of benchmarking. Since the initial measurement theoretically occurs before any additional workload, that initial measurement may be used as a theoretical processing maximum to compare subsequent measurements against.

Statistical models may be comprised where a cloud provider has infrastructure services that are adaptive. For example, a measurement at time To may not be comparable at time Tₙ if the cloud provider silently reconfigured between the two times. However, properly designed normalized unit should continue to be a normalized unit. Thus even if measurements may not be consistently comparable, the performance changes may be detected over time. Thus the adaptations of the cloud infrastructure and the triggers for those adaptations may be detected, and the benchmarking application may be configured to avoid those triggers or to compensate.

Yet another approach is to limit benchmarking under predetermined conditions. Some conditions are detected prior to benchmarking, and other conditions are detected during benchmarking. Regarding the former, given that the benchmarking application can negatively impact its environment, the central controller may have an “emergency stop” button customer that halts at least some of the benchmarking on at least some cloud provider instances under test. For example, a configuration file received by the benchmarking application may contain a “permit to run” flag. Before starting benchmarking, the benchmarking application may poll the central controller for the most recent configuration file. If there have been no changes the benchmarking application may receive a message indicating that the configuration file has not changed along with a set “permit to run” flag, and that the benchmarking application is permitted to start benchmarking. In this case, the benchmarking application will use the present configuration file and commence benchmarking. If the “permit to run” flag is not set, then the benchmarking application will not commence testing. In case where the benchmarking application cannot communicate with the central controller, the benchmarking application may default to not benchmarking and will assume the “permit to run” flag is not set. Regarding the detecting of conditions during benchmarking, the benchmarking application may gather at least some environment data for the cloud provider instance under test. If the benchmarking application detects that the environment data satisfies some predetermined condition, such as some or all of the current environment data being in excess of a predetermined level, then the benchmarking application may prevent benchmarking from starting.

Note that the benchmarking application under operation would only effect performance data collection, if at all. Thus functionality and characteristic data may continue to be collected without compromising the cloud performance instance under test.

In one embodiment, a benchmarking application may combine some of the above approaches. Specifically, a benchmarking application may maintain its own statistical information of measurements while making system measurements via direct system calls (i.e. ‘/proc’ interfaces, or devIoctls, etc.). Alternatively, the benchmarking application may store measurements locally for upload. The benchmarking may furthermore use compression techniques on the stored measurements or statistics. Note that if measurements were to be discarded and only the statistics retained internally, the footprint of the benchmarking application is likely to be much smaller than if all the raw measurements were retained.

The benchmarking application may make use of direct interfaces for at least the following reasons. One reason would be to keep system overhead to a minimum such that there is no appreciable impact to the statistical sets being acquired.

Another reason would be to reduce the overall “operating footprint” of the benchmarking application since it can also be collocated in a hosted environment with other applications and/or tools. In some measurements, a benchmarking application has been observed to consume less than 92 KB of RAM when passively monitoring operations.

It is not desirable for a benchmarking application suffer the impact of having a separate application-level process displace, or disrupt, its algorithmic continuum for harvesting statistical information. Alternatively, the benchmarking application could compensate for the overhead as described elsewhere herein.

Furthermore, the benchmarking application would upload collected measurements and/or statistics stored within the benchmarking application only when the benchmarking was completed. Specifically, the benchmarking application would be configured to perform benchmarking only for a predetermined time. After that predetermined time, or when measurements/benchmarking were not to be performed, the benchmarking application would connect to a network to upload the internally stored statistics and/or measurements. In this way, the network overhead to upload data would not impact benchmarking and/or measurement.

ii. Meaningful Statistics

Books have been written about how to characterize statistics. For some, the risk is that the consumer is overly credulous when confronted with statistics, and may conflate the reception of statistics with a full analysis in making a business decision. For others, the risk is that the consumer has been exposed to shoddy statistical analysis, and may be overly suspicious of all statistics. Benchmarking trustworthiness may be based on some of the following factors: the results are verifiable, the methodology is transparent and verifiably accurate, and the methodology is repeatable.

Consumer trust may be engendered by methodology transparency. For example, reporting may clearly indicate that a statistically significant amount of data has not yet been collected when reporting a benchmark. One way to ensure statistical significance is to take an initial measurement at the beginning of benchmarking and to track frequency/periodicity and timing of data sampling. Alternatively, reporting may indicate a confidence level, potentially calculated by the sampling frequency/periodicity and timing data. In this way, the consumer's desire for immediate data may be balanced against potential inaccuracies.

In addition to transparency, benchmarking may be performed by trusted third parties. Past benchmarks have been “gamed” by vendors, where the vendor implemented features specifically to optimize benchmark reports, without commensurate genuine improvements. While vendors may continue to game benchmarks, having a trusted third party owning the benchmarking infrastructure allows that third party to independently verify results, and modify the benchmarks as vendor gaming is detected.

Benchmarking is ideally repeatable. In other words, the performance reported by a benchmark should be similar to a separate test under similar test conditions. In general, samplings of indicia or benchmarking may be time/stamped. Accordingly, arbitrary time sets may be compared to each other in order to determine whether the benchmarking results were repeatable.

iii. Security

Benchmarking data and performance data are inherently sensitive. Cloud providers and VARs will not like poor performance results to be publicized. Furthermore, the integrity of the benchmarking system has to be protected from hackers, lest the collected results be compromised.

Security is to be balanced against processing overhead giving rise to a Heisenberg observation problem. For example, cryptography key exchange with remote key servers gives rise to network load. Such measurements may render at least network measurements inaccurate. However, sensitive data is ideally encrypted. Encryption overhead may be minimized by selectively encrypting only the most sensitive data and/or by encrypting portions of the data.

By way of an example, a benchmarking application may include a configuration file that may define the behavior of that benchmarking application. Therefore, the configuration file is to be delivered securely so that it is not a point of insertion for rogue instructions that would put the benchmarking operation at risk. The configuration file may be encrypted and/or make use of message digests to detect tampering. Hash algorithms and/or security certificates may be used to allow the benchmarking application to validate the configuration file prior to any benchmarking. For example, a configuration file may be identified as work only with a specified target cloud provider instance identifier, a version identifier, a time stamp, and a security identifier. The benchmarking application may be configured to only load and/or execute the configuration file only if some predetermined subset of these identifiers, or if all of these identifiers are validated and authorized.

Since the benchmarking application has not begun benchmarking prior to receiving and validating the configuration file, any network load from accessing key servers is not measured, and therefore will not cause a Heisenberg observation problem.

Note that the security of benchmarking is not the same as testing the security of the cloud provider. However, security testing of the cloud provider may be a function of the benchmarking application. Part of benchmarking applications capabilities may be to adapt its measurements based on an understanding of the relationship between both latency and security service checks. An initial benchmark measurement and can be validated across a number of clouds to identify the difference between the latency for a non-secure transaction and the latency for a security impacted latency for secure transactions. This difference may then be factored into the ongoing tests to confirm consistent performance.

### Context of Cloud Computing Benchmarking

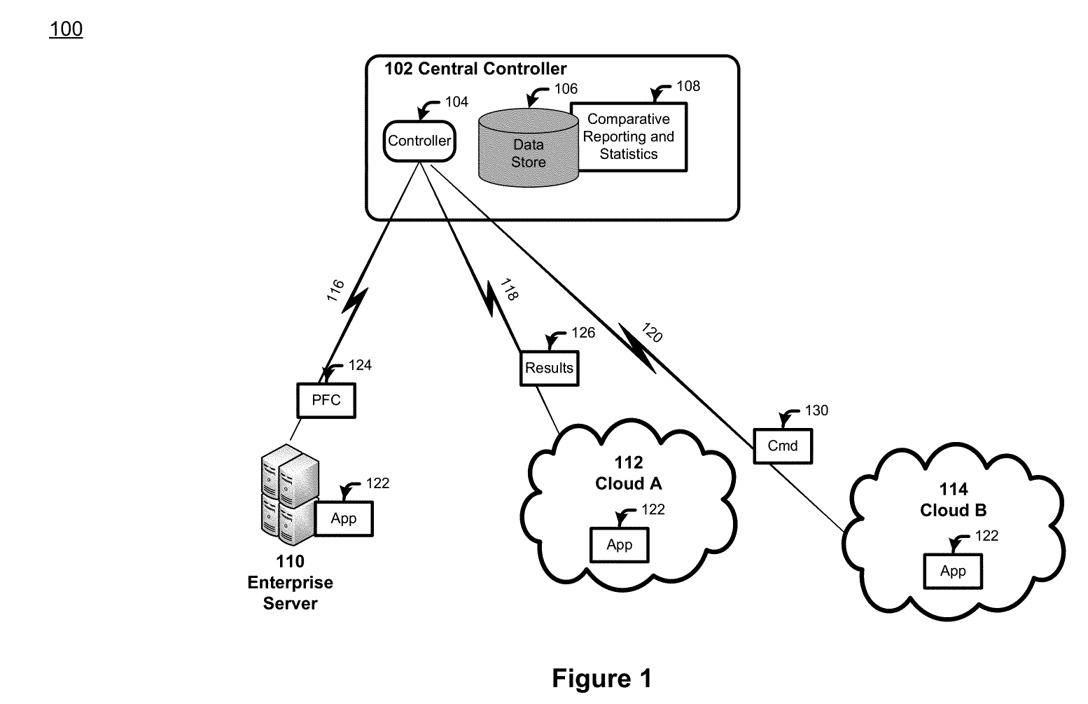

FIG. 1 is an exemplary context diagram for a cloud computing benchmarking infrastructure 100.

The cloud computing benchmarking infrastructure 100 may comprise a central controller 102. The central controller 102 may be local or remote to the cloud provider. For example, where the central controller 102 may be guaranteed to be in the same server cluster as the cloud provider instance under test, it may be desirable to host the central controller 102 locally as to reduce network latency. However, the central controller 102 may be located on a remote computer to provide a single point of control where multiple cloud provider instances are to be tested.

Central controller 102 may comprise a controller application 104 a data store 108 to store benchmarks, benchmarking results, configuration files, and other related data for cloud computing benchmarking. For example, in addition to storing benchmarking results and collected raw indicia data, the central controller 102 may perform comparative reporting and statistics, or other automated analysis, and store that analysis on data store 108.

The cloud computing benchmarking infrastructure 100 may benchmark enterprise servers 110 on a local area network (“LAN”). Alternatively, cloud computing benchmarking infrastructure 100 may benchmark one or more clouds 112, 114. Note that clouds 112, 114 need not be the same type of cloud. For example, cloud 112 may be a PAAS infrastructure and cloud 114 may be a SAAS infrastructure. Communications connections between the central controller 102 and enterprise servers 110 and clouds 112 and 114 may be effected via network connections 116, 118, 120 respectively.

Network connections 116, 118, 120 may be used to send/install a benchmarking application 122 on enterprise servers 110 and/or clouds 112, 114.

Once benchmarking application 122 is installed, the benchmarking application 122 may request a configuration file 124 indicating which PFC are to be collected may be sent to enterprise servers 110 and/or clouds 112 from central controller 102. Accordingly, the benchmarking application 122 may operate on a pull basis. Alternatively, central controller 102 may push a configuration file 124 to enterprise servers 110 and/or clouds 112.

Periodically, benchmarking application 122 may send benchmarking data results 126 back to the central controller 102 for storage in data store 108. The sending may be based on a predetermined condition being detected, such as benchmarking completing. Alternatively, the central controller 102 may affirmatively request some or all of the benchmarking data results 126.

The central controller 102 may affirmatively send commands 130 to the benchmarking application 122. For example, it may send a “permit to run” flag set to “on” or “off” In the latter case, the benchmarking application may stop upon reception of command 130.

### Exemplary Hardware Platform for Cloud Computing Benchmarking

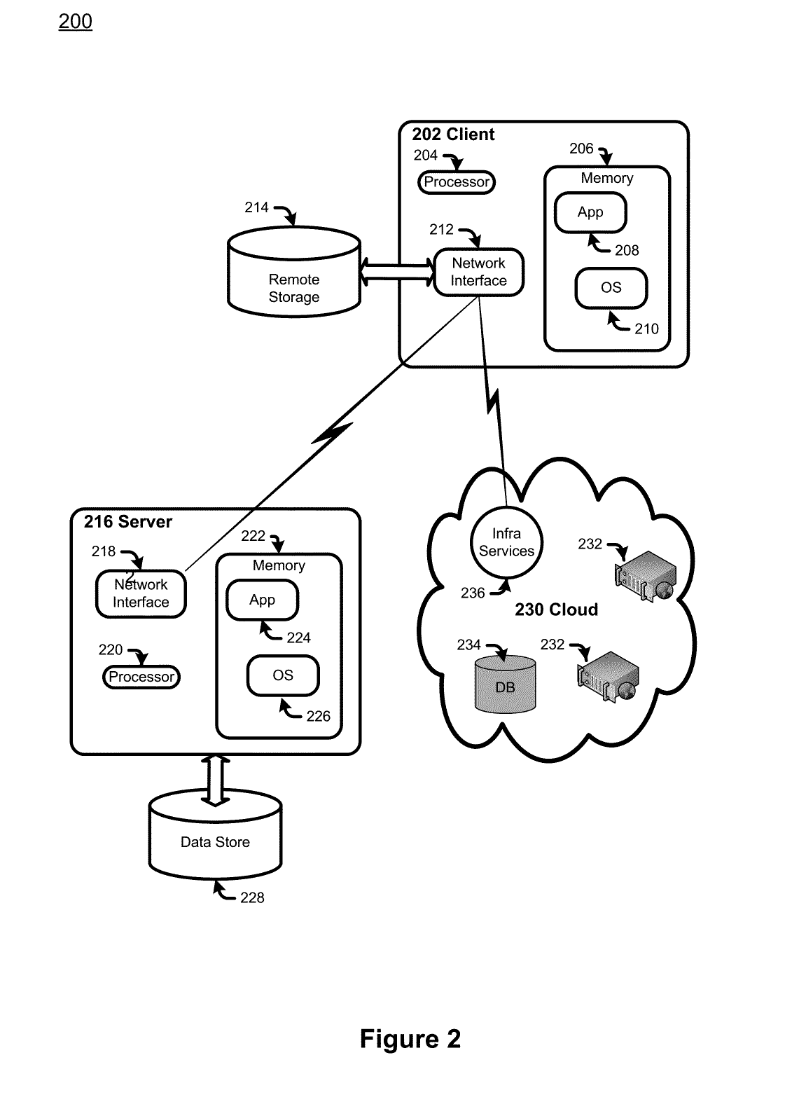

FIG. 2 illustrates one possible embodiment of a hardware environment 200 for cloud computing benchmarking.

Client device 202 is any computing device. A client device 202 may have a processor 204 and a memory 206. Client device 202's memory 206 is any computer-readable media which may store several programs including an application 208 and/or an operating system 210.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

To participate in a communications environment, client device 202 may have a network interface 212. The network interface 212 may be one or more network interfaces including Ethernet, Wi-Fi, or any number of other physical and data link standard interfaces. In the case where the programming language transformations are to be done on a single machine, the network interface 212 is optional.

Client device 202 may use the network interface 212 to communicate to remote storage 214. Remote storage 214 may include network aware storage (“NAS”) or may be removable storage such as a thumb drive or memory stick.

Client device 202 may communicate to a server 216. Server 216 is any computing device that may participate in a network. Client network interface 212 may ultimate connect to server 216 via server network interface 218. Server network interface 218 may be one or more network interfaces as described with respect to client network interface 212.

Server 216 also has a processor 220 and memory 222. As per the preceding discussion regarding client device 202, memory 222 is any computer-readable media including both computer storage media and communication media.

In particular, memory 222 stores software which may include an application 224 and/or an operating system 226. Memory 222 may also store applications 224 that may include a database management system. Accordingly, server 216 may include data store 228. Data store 228 may be configured as a relational database, an object-oriented database, and/or a columnar database, or any configuration to support policy storage.

Server 216 need not be on site or operated by the client enterprise. Server 216 may be hosted in a cloud 230. Cloud 230 may represent a plurality of disaggregated servers which provide virtual web application server 232 functionality and virtual database 234 functionality. Cloud 230 services 232, 234 may be made accessible via cloud infrastructure 236. Cloud infrastructure 236 not only provides access to cloud services 232, 234 but also billing services. Cloud infrastructure 236 may provide additional service abstractions such as Platform as a Service (“PAAS”), Infrastructure as a Service (“IAAS”), and Software as a Service (“SAAS”).

### Exemplary Architecture for Cloud Computing Benchmarking

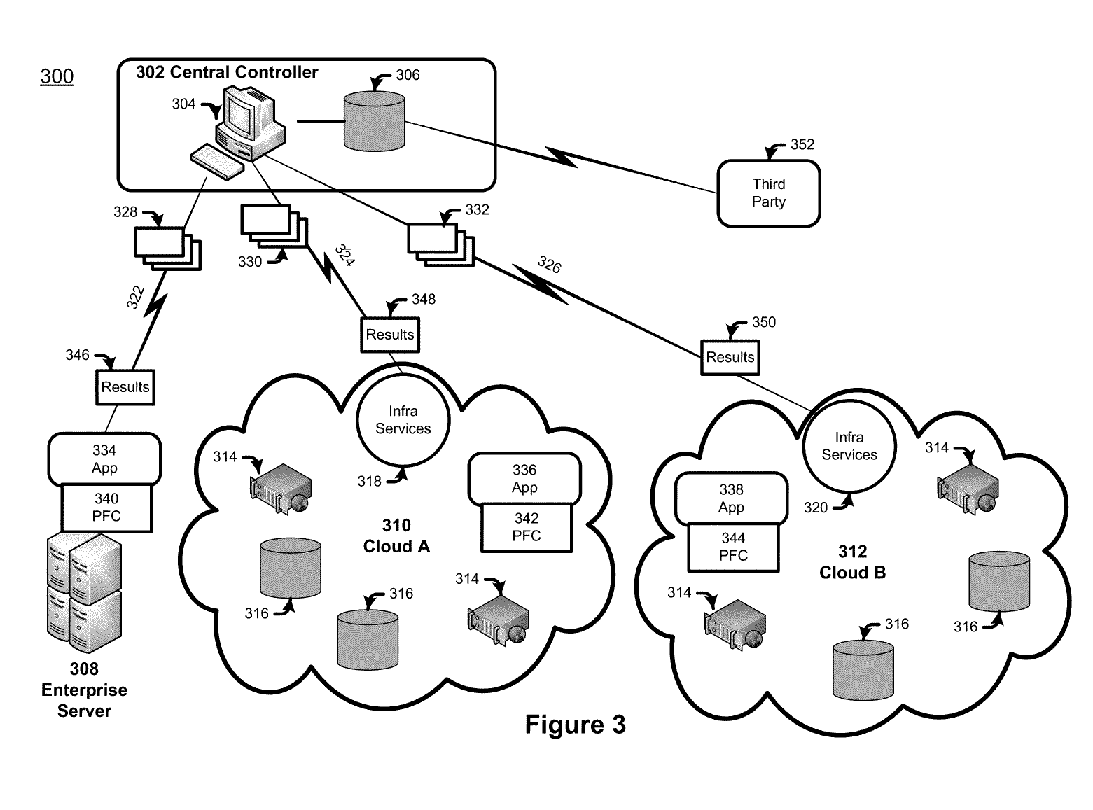

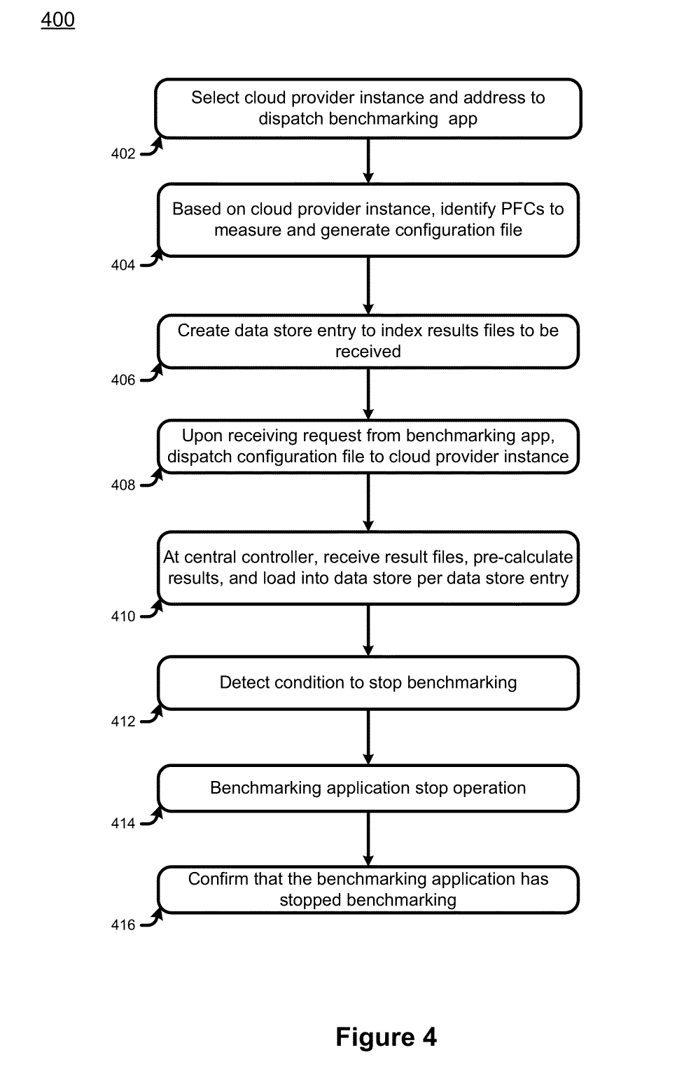

FIG. 3 is an exemplary detailed system diagram of the example operation of a cloud computing benchmarking infrastructure 300. FIG. 3 expands on the high level system diagram of FIG. 1. FIG. 4 illustrates a flowchart 400 of the example operation of cloud computing benchmarking infrastructure 300.

Central controller 302 comprises a computer 304 hosting a controller application (not shown) and data store 306. In the present example, central controller 302 is to benchmark enterprise server 308 on a LAN, Cloud A 310 and Cloud B 312.

Clouds A and B 310, 312 may include disaggregated application servers 314 and disaggregated data storage 316 either exposed via a file system or database management system. Cloud A 310 and Cloud B 312 each expose cloud functionality through their respective infrastructure services 318 and 320.

Central controller 302 may communicate with enterprise server 308, Cloud A 310, or Cloud B 312 via communications connections 322, 324, 326 respectively. Over communications connections 322, 324, 326, executables, configuration files, results, commands, and generally arbitrary data 328, 330, 332 may be transmitted and received without loss of generality.

In block 402 of FIG. 4, the central controller 302 will initially select one or more cloud provider instances to benchmark. Upon selection, the central controller 302 identifies the network addresses of the selected cloud provider instances, and dispatches benchmarking applications 334, 336, 338.

While dispatching benchmarking applications 334, 336, 338, in 406 of FIG. 4, the central controller 302 creates data entries in data store 306 to store and/or index anticipated received results from the dispatched benchmarking applications 334, 336, 338.

Upon arrival, benchmarking applications 334, 336, 338 will instantiate. In block 408 of FIG. 4, central controller 302 will dispatch configuration file 340, 342, 344. Specifically, after instantiation, benchmarking applications 334, 336, 338 will first determine whether there is configuration file to load. If no configuration file is available, the benchmarking applications 334, 336, 338 affirmatively poll central controller 302 for a configuration file. Central controller 302 generates configuration files by identifying relevant PFCs for the respective platform. Candidate PFCs are described with respect to Tables 1-7 above.

The configuration file 340, 342, 344 provides for separation data and metadata, which enable versioning. This enables for measurements based on a data point to be collected and tied to a particular version and a particular set of applicable predictive models. For each new version, the benchmarking application 334, 336, 338 may then validate data for backwards compatibility, and adapts the metadata based on usability. At this point the metadata is assigned and maintained by the central controller 102 and serialized such that the configuration file 340, 342, 344 carries the metadata tag through benchmarking operations to ensure that the data sets are collected and stored with the metadata version for tracking, auditability and certification.

The data is also keyed and/or serialized to a given cloud provider instance where its respective benchmarking application 334, 336, 338 is executing, since cloud provider instances are both temporal in location and existence. Several services are activated by benchmarking measurements over time. An example of such a service will be for a cloud provider to use the benchmarking measurements to move workloads between cloud provider instances as to ensure minimize impact to the overall workload. Another example may be the ability to enable hibernation of cloud instances, such as development and test instances, that are only needed sporadically, but may be restarted quickly while ensuring that the restarted instances meet the same benchmarking measurements before. Over time, the benchmarking measurements may enable analyzing service performance trends across interruptions in service,

Additionally, tracking metadata and the cloud computing instance, enables cross correlation of benchmarking measurements both within the same cloud provider and between different cloud providers. For example, two very different customers may select a similar application profile comprised of one or more PFCs and/or indicia. Comparison is only possible if the PCFs and/or indicia are of a common specific test methodology and serialized for analysis against consistent benchmarking algorithms.

The benchmarking applications 334, 336, 338 will perform several checks prior to initiating benchmarking. First the benchmarking applications 334, 336, 338 authenticate and validate the configuration files 340, 342, 344 as described previously. The benchmarking applications 334, 336, 338 will then affirmatively poll for a new version from the central controller 302. If there is a new version, then the new version is retrieved. Otherwise, a command indicating that the benchmarking is “permitted to run” is dispatched by the central controller 302. Furthermore, the benchmarking applications 334, 336, 338 will determine if its local environment has sufficient capacity to perform benchmarking. The benchmarking may be in the form of measuring known PFCs. If there is sufficient capacity, then the benchmarking applications 334, 336, 338 may instantiate other executables or scripts (not shown) to aid in benchmarking.

A configuration file may include some of the following features:

Job Identity—Each deployment of a benchmarking application is associated with its own unique identity.

Job Duration—Each deployment of a benchmarking application is associated with the amount of time that the SmartApp™ is to be deployed and operable under test.

Time Between Upload—benchmarking application will alternate between applying load to the cloud system and uploading data. The Execution Interval is the time between upload.

Applied Load Time—The Execution Duration is the time that applied load time for a deployment. It is the Job Duration minus upload time and down time.

Network or File Persistence—The benchmarking application may select how to persist measurements. Measurements may be stored in a file or directly streamed over the network.

Persistence Format—There are different persistence formats that may be supported by a configuration file. JSON files or text files are possible. Also a prorprietary .KJO binary format is also supported.

Targeted Network Output Persistence—The different attributes may specify an arbitrary target URL to store measurement/log data.

Profiles—One feature described herein is the ability to specify a load that matches the expected behavior of an arbitrary application. This is achieved by identifying different attributes for applications, and then enabling load generation on a per attribute basis. Attributes may be attributes relating to compute load, memory load, file input/output load, and network input/output load. Some applications may be compute bound (processor bound), others memory bound, and so on. This may be simulated by defining a profile that specifies what load to apply to each of the attributes. Profiles may be default profiles and others may be custom profiles.

Multiple Thread Pools—To implement load generation on a per attribute basis, the benchmarking application may manage multiple thread pools. Thread pools may relate to:
1. Compute (load in the form of computing prime numbers)
2. Memory
3. File input/output
4. Network input/output
   However, other thread pools could be implemented and configured.

Benchmarking applications 334, 336, 338 then make an initial PFC and time stamp measurement. This initial PFC measurement provides a baseline for comparing future measurements. During the benchmarking cycle, the benchmarking applications 334, 336, 338 may periodically or upon detecting an event take PFC measurements.

A feature of the benchmarking application is that it may support variable intensity for an arbitrary attribute. This is made possible not only by having one or more thread pools as described above, but also by providing each thread pool with its own set of configuration properties, all of which may be independently configured.

One of the configuration properties for the thread pool is Intensity. Intensity is presently a 12 value field (0 through 11). Since the dispatching central controller can remotely configure a deployed benchmark application, the dispatching central controller may scale the load on individual attributes or may scale multiple attributes in combination.

By way of example for an individual attribute scenario, consider a network bound application. The dispatching central controller could pick a compute related attribute, and increase the compute load to determine the point where the application become compute bound rather than network bound. In other words, one could determine when a failing of the cloud provider occurred rather than a potential failing of the intervening network infrastructure out of the control of the provider.

By way of example for a multiple attribute scenario, consider a benchmarking application configured to provide an application simulation load as specified by a profile. A dispatching central controller could be programmed to proportionally increase the load on all attributes at the same time. For example, consider a memory attribute set to 4 out of 12 and a file input/output attribute set to 6 out of 12. One may desire to observe a 50% proportional increase in load. This would then increase the memory attribute to 6 out of 12 and the file input/output attribute to 9 out of 12. Most certainly other relationships could be observed as well.

In sum, a benchmarking application may provide not only for generating load on a per attribute basis, but also for allowing for the scaling of the generated load either independently, together, or in conjunction with each other, each with its own configurable independent thread pool. In this way, a benchmarking application may support the automated generation load for an arbitrary application and for arbitrary environmental constraints.

The measurements by benchmarking applications 334, 336, 338 are persisted to local storage. Alternatively, statistics are calculated on the measurements, the measurements discarded, and only the calculated statistics persisted to local storage or stored internally to the benchmarking applications 334, 336, 338. When the central controller 302 requests the results, or when a predetermined condition is satisfied, the benchmarking applications 334, 336, 338 transmit at least some of the persisted measurements as results 346, 348, 350 back to central control 302 for storage in data store 306.

In block 410 of FIG. 4, when central controller 302 receives results, it may perform store the raw results, or otherwise perform some precalculations of the raw data prior to storing in data store 306.

Proceeding to block 412 of FIG. 4, benchmarking applications 334, 336, 338 eventually detect a condition to stop benchmarking. One condition is that the benchmarking is complete. Another condition is that the benchmarking applications 334, 336, 338 have lost communications with central controller 302. Yet another condition is the detection that capacity PFCs the local environment benchmarking applications 334, 336, 338 exceed a predetermined threshold. Finally, another condition is the reception of a negative “permit to run” flag or a command from the central controller 302 to cease execution. Upon detecting any of the conditions, in block 414 of FIG. 4, benchmarking applications 334, 336, 338 stop benchmarking. Optionally, in block 416, central control 302 may verify that the benchmarking applications 334, 336, 338 have stopped benchmarking.

### Platform Performance Management

With the differences between cloud service providers in implementation as well as models in exposing service, it is difficult for a customer to compare cloud service provider performance. Specifically, the cloud services provider's “platform” may be defined as the operating environment of that cloud service provider, including the operating system, a virtualization layer, execution engine/virtual machine, and system services made available via the cloud provider's offering. Managing a platform would comprise determining whether the platform is adequate to a stated task, and modifying the platform as needed. For example a customer would need to ensure that a hosted application performed adequately under use, or determine whether a cloud service provider was honoring its SLA, or determine whether to add more computing resources through the virtualization layer, or determine whether to change cloud service providers and identify a suitable cloud service provider to move to. Such management decisions may be collected under the term, “Platform Performance Management” (“PPM”).

At the heart of PPM is measurement. Determining whether a platform is adequate to a stated tasks means measuring the performance of that task on the platform under test. The measurement is typically measured using unitary measures of known performance. Such measurement is generally known as benchmarking.

### Comprehensive, Concurrent, Multi-Dimensional Benchmarking

In order for benchmarking to provide useful measures, the unitary measure used to benchmark must apply across different cloud service provider implementations and different service models. Regardless if an application is performing on Google PaaS or IBM IaaS, the resulting measures should be comparable. Furthermore, the measures should scale such that arithmetic operations may be performed. For example, if a first cloud service provider yields a measurement of two (2) and a second cloud service provider yields a measurement of six (6), then we should be able to conclude that the second cloud service provider is three times more performant in that measure than the first cloud service provider. In this way, statistical operations (such as standard deviation) may be meaningfully applied to the measurements as described above.

A cloud unitary measure would have these attributes. Where other measurement might only provide a measurement for a single attribute of compute server performance, such as CPU cycles or network latency, a cloud unitary measure is a single unitary measure that is comprehensive, concurrent, and multi-dimensional. Specifically:
Comprehensive—A cloud unitary measure may be thought as a vector comprised of a selection of attributes to measure against a compute server. The selection is from the superset of all measures that may be measured against a compute server. Thus the cloud unitary measure is comprehensive in the sense that it has a measure representing every major attribute of a compute server provided by a cloud service provider.
Concurrent—Whereas many benchmarks require separate runs to measure all the attributes measured by a cloud unitary measure, the cloud unitary measure may be measured concurrently in the same run. In this way, there is data for different attributes may be properly grouped together, rather than merging data from different runs.
Multi-Dimensional—As previously stated, the cloud unitary measure is comprised of different measures of attributes of a compute server. Some measures may be dependent on other measures, which is to say they may be derived from other measures. Ideally, the selected attributes will be independent of each other. Thus the cloud unitary measure is not just multi-dimensional in the sense that there are multiple measures aggregated in a cloud unitary measure, but also multi-dimensional in the sense that each measured attribute in the cloud unitary measure is independent, and therefore mathematically orthogonal to each other. Specifically, each measured attributed in a cloud unitary measure cannot be derived from another measured attribute in a cloud unitary measure. But any compute server measure can be derived from a linear combination of one or more measured attributes in a cloud unitary measure.

### Architecture Recap

Benchmarking infrastructure as described above generally comprises a dispatcher and a load generation application. For a system under test, the dispatcher will install an instance of the load generation application and will send over a configuration file defining behaviors of the load generation application. The configuration file may define both behaviors of the load generation application for the test as a whole, or for specific attributes.

For the test as a whole, the configuration file may specify;
1) Job Duration—This is the period of time that the load generation application is to stay installed on the system under test. Note that the load generation application may not be generating load continuously during this time period.
2) Execution Interval—The load generation application will select time periods to upload measurement data to avoid interfering with test results. Specifically, the measurement will generally create disk load for the data being generated, and network load, when the generated data is uploaded. The load generation application may select times to upload data where data quantity and system load is well understood. As a result, the load generation application may modify the measurements to subtract out the load attributable to the test, thereby providing an accurate measurement.
3) Execution Duration—This is the amount of time that the load generational application is executing load during the Execution Interval. Unlike Job Duration, Execution Duration is the actual execution time of the load generation application.

The configuration file may also specify the behavior of the load generation application on a per attribute basis. For each attribute in a cloud unitary measure, there are one or more algorithms designed to simulate load for that attribute. The configuration file may specify the intensity of the load simulation. In a sense, the configuration file settings for attributes could be envisioned as a set of “slider” controls, similar to that of a graphic equalizer, indicating the degree of intensity of the load generation application for each attribute to be measured. In some cases, intensity will either be on or off. For example, there is no need to simulate video load on a non-multimedia application. Other attribute measures may scale. For example, network output could be simulated as high (as to simulate a video streaming app), or medium (as to simulate bursty output behavior of web text pages with caching). Additionally, for some measured attributes, other configuration properties may be specified (e.g. constant v. bursty network traffic).

The benchmarking application generally will make use of measured attributes via public application programming interfaces, either from the cloud service provider, or from the operating system. However, in some cases, the load generation application may be configured to collect data from internal interfaces, such as the cloud service provider's virtualization layer. In this way, the load generation application may be used to collect cloud unitary measures specific to cloud service providers, whereby the cloud service provider may tune their services.

### Various Use Cases and Scenarios in PPM

As stated above, the benchmarking application collects cloud unitary measures that are comparable across different cloud service provider implementations and different service models. The benchmarking application may collect data on an application at two different times on the same cloud instance of a cloud service provider, or on an application on two different cloud service providers.

In order to simulate an application, an application profile comprising a plurality of application properties is collected. The application profile may be stored in a configuration file. The different application properties are set to an intensity level according to a configuration property as described above. An application property may vary over time, either as programmed locally or alternative via receipt of an input configuration property, usually from the central controller. A configuration property may alter the value of a single application property or a plurality of application properties. When the benchmark application starts benchmarking, it will run the application profile by creating load on the specified application properties, by running a proportional number of threads from the benchmarking applications thread pool.

Upon measurement of benchmarking indicia, either the measurements, or statistics on the measurements, or both, are stored locally. After benchmarking, the stored statistics and/or measurements are uploaded to a database accessible by the central controller. From the database a measurement report summarizing the performance, usually in the form of cloud unitary measures may be made.

Because cloud unitary measures are used to generate the reports, an application's performance may be compared on the same cloud instance over time. Thus one could perform historical benchmarking of that cloud instance, specifically to determine over time the historical performance of that cloud instance. Alternatively, one could perform service level agreement compliance by that cloud instance over time, specifically one could see if the service level agreement of the cloud provider was honored consistently over long periods of time.

Similarly, because cloud unitary measures are used to generate the reports, an application's performance could be compared across different cloud service providers. One could benchmark the application on a first cloud service provider, and the application on the second cloud service provider. One could thereby compare the performance of the first cloud service provider with respect to the second cloud service provider, even though the two service provider used different infrastructure. Similarly, once could compare compliance of service level agreements over time, and generally compare performance of two cloud service providers over time, by benchmarking the two cloud service providers at the same time, and with the same sampling frequency.

The following are some business based use cases and scenarios describing how the load generation application will perform.
1. Catastrophic Failure of the System under Test—A poor cloud service provider may have a virtual machine crash. In this case, the benchmarking application will cease operation since its operating environment crashes. The dispatcher can detect whether the system under test crashed by attempting to contact the virtual machine. Accordingly, the dispatcher can flag the uploaded test results accordingly.
2. Debug Mode—There may be bugs in the load generation application. The benchmarking application may have a mode where in addition to measuring attributes specific to the cloud service provider platform, but also attributes of the load generation application. For example, the load generation application may track allocated thread count or allocated memory to determine whether a thread or memory leak exists in the load generation application.
3. Metering for Billing—While benchmarking services may be provided on a flat fee basis, one business model for benchmarking may be to charge by amount of benchmarking. As a variation of debug mode, described above, the benchmarking application may track the amount of time it actually executed, or the amount of data it collected. In this way the load generation application could be self-metering for billing purposes to customers paying for benchmarking services. While the configuration file specifies how long the test is to operate e.g. execution duration, the load generation application could verify that the specified execution duration was in fact honored.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system to benchmark infrastructure, comprising:
a cloud provider with at least one processor;
memory communicatively coupled to at least one processor;
a benchmarking application for the cloud provider resident in the memory and executable on the at least one processor to generate a load on the cloud provider, measure at least one benchmark indicia for a predetermined amount of time, and after the predetermined amount of time stops measurement of the at least one benchmark indicia, and creates a network connection to upload the at least one measured benchmark indicia to the database.

2. The system of claim 1, wherein the benchmark application stores a statistical calculation performed on the at least one measured benchmark indicia internally to the benchmark application during the predetermined amount of time.

3. The system of claim 1, wherein the benchmark application performs either the load generation or the measurement of the at least one benchmark indicia, or both, at least partially via direct system calls.

4. The system of claim 1, wherein the at least one benchmark indicia to be measured by the dispatched benchmark application is specified by a dispatched configuration file.

5. The system of claim 4, wherein the dispatched configuration file specifies a benchmark indicia specific to a 64-bit operating system.

6. The system of claim 5, wherein the dispatched configuration file specifies a vendor independent benchmark indicia specific to a 64-bit operating system.

7. The system of claim 4, wherein the dispatched configuration file specifies at least one of the following:
job duration;
time between upload;
applied load time;
whether to store indicia on the network or on a file;
persistence format; and
targeted network output persistence.

8. The system of claim 4, wherein the dispatched configuration file specifies an application profile.

9. A system to benchmark infrastructure, comprising:
a cloud provider with at least one processor;
memory communicatively coupled to at least one processor;
a benchmarking application for the cloud provider resident in the memory and executable on the at least one processor to generate a load on the cloud provider according to a configuration property,
wherein the benchmarking application comprises at least one thread pool, and the benchmarking application generated the load on the cloud provider using the at least one thread pool.

10. The system of claim 9, wherein the configuration property is variable.

11. The system of claim 10, wherein the benchmarking application modifies the generated load on the cloud provider at least as the configuration property varies.

12. The system of claim 11, wherein the benchmarking application is configured to have network connectivity over a network, and varies the configuration property based on an input received over the network.

13. The system of claim 12, wherein the benchmarking application modifies the generated load on the cloud provider by varying the number of threads activated from the at least one thread pool.

14. A method to benchmark a cloud computing instance, comprising:
receiving at a central controller a network address of the cloud computing instance;
dispatching a benchmarking application from the central controller to the cloud computing instance at the network address via a network connection between the central controller and a server executing the cloud computing instance; and
executing the benchmarking application on the cloud computing instance to make a measure of a plurality of application properties, the plurality of application properties comprising an application profile corresponding to an application.

15. The method of claim 14, comprising storing the measured application properties on a database and generating a measurement report of the application.

16. The method of claim 15, comprising executing the benchmarking application on the cloud computing instance to make an additional measure of the plurality of application properties that comprise the application profile corresponding to the application, and storing the second measured application properties on a database and generating an additional measurement report of the application.

17. The method of claim 16, comprising comparing the measurement report of the application and the additional measurement report of the application in order to perform at least one of the following analyses:
service level agreement compliance analysis;
performance debugging of the application; and
historical benchmarking on the cloud provider.

18. The method of claim 15, comprising executing the benchmarking application on an additional cloud computing instance to make an additional measure of the plurality of application properties that comprise the application profile corresponding to the application, and storing the additional measured application properties on a database and generating an additional measurement report of the application.

19. The method of claim 18, comprising comparing the measurement report of the application and the additional measurement report of the application in order to perform at least one of the following analyses:
comparing performance of different cloud providers;
comparing service level agreement compliance of different cloud providers; and
historical benchmarking of different cloud providers.

20. A method to benchmark a cloud computing instance, comprising:
receiving at the cloud computing instance a benchmarking application, the benchmarking application comprising at least one thread pool;
receiving at the cloud computing instance a configuration file containing an application profile comprising a plurality of benchmarking indicia, and one or more variable configuration properties;
generating a load on the cloud computing instance via the benchmarking application based at least on the received configuration file;
receiving an input at the benchmarking application to vary a variable configuration property; and
varying the load on the cloud computing instance by varying a number of active threads in the at least one thread pool based at least on the varied variable configuration property.
